(19) United States
(12) Patent Application Publication
(10) Pub. No.: US 2009/0125528 A1
(43) Pub. Date: May 14, 2009

(54) Apparatus and Method For Classifying E-Mail Using Decision Tree

(75) Inventor: Minn-Seok Choi, Daejon (KR)

Correspondence Address: RABIN & Berdo, PC, 1101 14TH STREET, NW, SUITE 500, WASHINGTON, DC, 20005, US

(73) Assignees: Electronics and Telecommunications Research Institute, Daejon (KR); KT Corporation, Seongnam-city (KR)

(21) Appl. No.: 11/719,079

(22) PCT Filed: Dec. 30, 2004
(86) PCT No.: PCT/KR04/03538

§ 371 Date: May 10, 2007

(30) Foreign Application Priority Data
Nov. 10, 2004 (KR) 10-2004-0091585
Dec. 13, 2004 (KR) 10-2004-0104908

(51) Int. Cl. G06F 17/30

(52) U.S. Cl. 707/100; 707/E17.044

(57) ABSTRACT

An apparatus and method for classifying e-mails using a decision tree is disclosed. The apparatus includes: a client e-mail storing unit for storing e-mails according to each folder; a decision tree generating unit for generating a decision tree based on information about e-mails stored according to folders in the client e-mail storing unit; a received e-mail processing unit for receiving e-mails; an e-mail storing unit for storing the e-mails received in the receiving e-mail processing unit; an e-mail classifying unit for classifying the e-mails stored in the e-mail storing unit based on the decision tree; an e-mail transmitting unit for transmitting the classified e-mail to the client e-mail storing unit; and a controlling unit for controlling the units to generate the decision tree based on the e-mails stored in the client e-mail storing unit and to classify the e-mail transmitted from outside based on the decision tree.

### TECHNICAL FIELD

The present invention relates to an apparatus and method for classifying an e-mail by using a decision tree; and, more particularly, to an e-mail classifying apparatus based on a decision tree that generates a decision tree based on information about a folder created by a client and the e-mail stored therein, and classifies an e-mail transmitted from the outside based on the decision tree, and a method thereof.

### BACKGROUND ART

Invention of the Internet and Web has led an electric mail (e-mail) to worldwide popularity, and the e-mail has become a representative application program in the age of information and communication. The modern people living in the 21^{st} century receive and send a number of e-mails everyday and treat the e-mail as an important communication medium together with telephone numbers. As communication through the e-mail prevails, a method for managing e-mails effectively is in demand.

Since the e-mail was sent and received by using a small capacity of e-mail client program or a Web in the early days of the e-mail, importance lies on periodic deletion of the e-mails than on systematic classification of the e-mails sent or received. Even if the e-mails need to be classified, the e-mails were manually classified by a user.

However, since an increasing number of users are provided with a large-capacity mailbox recently and exchanges tens or hundreds of e-mails everyday, they divide the mailbox into a plurality of folders and classify the e-mails into the divided folders. Particularly, effective management of e-mails increasing explosively has become an important issue to a user using a push-type e-mail service, such as on-line newsletters.

Meanwhile, a decision tree learning technique is a representative learning technique of an inductive inference. The decision tree learning technique is commonly used for classification. Generally, the decision tree learning technique has a characteristic that it has robustness to noise.

The decision tree includes a plurality of nodes. The node on top in the decision tree is called a root node. The decision tree is grown up by pruning child nodes out of the root node. Herein, the node at the bottom of the decision tree is called a leaf node. The iteration of pruning stops at the leaf node. The steps from the root node to the leaf node are called depth.

The decision tree learning technique forms a tree-type classifying model based on collected data and classifies received data according to the classifying model. Therefore, the decision tree learning technique is regarded as an excellent automatic classifying method.

Conventional automatic e-mail classifying methods classify e-mails based on an assumption-and-decision method. That is, they classify the e-mails according to predetermined rules defined based on sender address, title and contents of an e-mail. Once the rules are defined that if a classifier, such as the sender address, title and contents, has a specific value, the e-mail is automatically classified into a specific folder, the e-mails received after the definition of the rules are classified according to the rules.

For example, when it has rules that “I go for exercise if the sun rises and humidity is in a regular range” and “I go for exercise if it rains and it is a bit windy,” the conclusion is “I go for exercise automatically if the sun rises and humidity is in a regular range.” On the other hand, if the sun rises and humidity is not in a regular range, no conclusion can be obtained because there is no rule that can be applied to the case.

That is, the automation based on rules is very simple and effective when a dichotomic decision is faced or there are a couple of variables and a few cases. However, it has following drawbacks.

At first, it requires large amount of time for generating and managing necessary rules when the number of e-mails to be processed increased dramatically. That is, it requires rules as many as the numbers of the values each classifier has are multiplied in order to classify e-mails. If the number of variables and cases increase, a great deal of rules should be created.

Secondly, it is time-consuming to set up rules for detailed classification in the conventional e-mail classifying method based on rules. For example, the rule must be defined by carefully considering other variables except e-mail address to transfer an e-mail sent out from one e-mail address to different folders. The rules may not be applied effectively according to the characteristics of an added variable.

### DISCLOSURE

### Technical Problem

It is, therefore, an object of the present invention to provide an e-mail classifying apparatus and method based on a decision tree that can classify many e-mails simply and rapidly based on the decision tree by generating the decision tree based on information about a folder created by a client and an e-mail stored therein and classifying the e-mail based on the decision tree.

The other objects and advantages of the present invention can be understood from the following description and become apparent from the description of the preferred embodiments. Also, it can be easily understood that the objects and the advantages of the present invention can be realized by the means as claimed and combinations thereof.

### Technical Solution

In accordance with an aspect of the present invention, there is provided an apparatus for classifying e-mails using a decision tree, the apparatus including: a client e-mail storing unit for storing e-mails according to each folder; a decision tree generating unit for generating a decision tree based on information about e-mails stored according to folders in the client e-mail storing unit; a received e-mail processing unit for receiving e-mails; an e-mail storing unit for storing the e-mails received in the receiving e-mail processing unit; an e-mail classifying unit for classifying the e-mails stored in the e-mail storing unit based on the decision tree; an e-mail transmitting unit for transmitting the classified e-mail to the client e-mail storing unit; and a controlling unit for controlling the units to generate the decision tree based on the e-mails stored in the client e-mail storing unit and to classify the e-mail transmitted from outside based on the decision tree.

In accordance with another aspect of the present invention, there is provided a method for classifying e-mails based on a decision tree, the method including the steps of: a) generating a decision tree based on information about folders created by a client and e-mails stored in the folders; b) temporally storing e-mails transmitted from outside in an e-mail storing means; c) comparing correlation between the folders and the stored e-mail based on the decision tree; d) determining a folder having highest correlation with the stored e-mail based on the comparison; and e) storing the e-mail in the above determined folder.

### ADVANTAGEOUS EFFECTS

The present invention can classify a great deal of electric mails (e-mails) simply and rapidly by generating a decision tree based on folders created by a client and information that e-mails stored therein, and classifying the e-mails transmitted from the outside based on the created decision tree.

Also, the present invention can provide differentiated additional service to clients by analyzing an e-mail classification pattern of a client.

In addition, since the present invention classifies e-mails for each folder based on the decision tree, no additional usage directions need to be learned, which enhances convenience on the client's part.

### DESCRIPTION OF DRAWINGS

The above and other objects and features of the present invention will become apparent from the following description of the preferred embodiments given in conjunction with the accompanying drawings, in which:

FIG. 1 is a block diagram showing an e-mail classifying apparatus using a decision tree in accordance with a preferred embodiment of the present invention;

FIG. 2 is a diagram showing e-mails of each folder in a client E-mail storing unit in accordance with a preferred embodiment of the present invention;

FIG. 3 is a flowchart describing a method for generating a decision tree in accordance with a preferred embodiment of the present invention;

FIG. 4 shows a decision tree in accordance with a preferred embodiment of the present invention; and

FIG. 5 is a flowchart describing a method for classifying e-mails based on a decision tree in accordance with a preferred embodiment of the present invention.

### BEST MODE FOR THE INVENTION

Other objects and aspects of the invention will become apparent from the following description of the embodiments with reference to the accompanying drawings, which is set forth hereinafter.

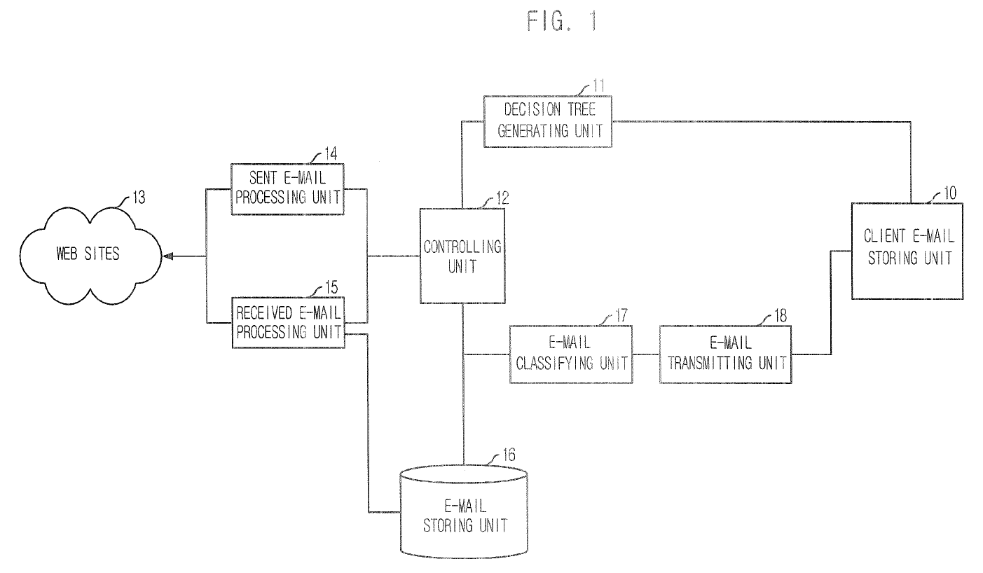

FIG. 1 is a block diagram showing an e-mail classifying apparatus using a decision tree in accordance with a preferred embodiment of the present invention.

As shown in FIG. 1, the apparatus for classifying e-mail using the decision tree includes a client e-mail storing unit 10 for storing an e-mail according to a folder; a decision tree generating unit 11 for generating a decision tree based on information about the e-mail stored according to a folder in the client mail storing unit 10; a received e-mail processing unit 15 for receiving e-mails from web-sites; an e-mail storing unit 16 for storing the e-mail received in the received e-mail storing unit 15; an e-mail classifying unit 17 for classifying e-mails stored in the e-mail storing unit 16 by using the decision tree; an e-mail transmitting unit 18 for transmitting the classified e-mail in the e-mail classifying unit 17 to the client e-mail storing unit 10; and a controlling unit 12 for controlling the aforementioned units for generating the decision tree based on information about the folder generated by the client and about the e-mail stored in the generated folder and classifying the e-mail using the generated decision tree when the e-mail is received.

The apparatus for classifying e-mail using the decision tree further includes a sent e-mail processing unit 14 for sending an e-mail from the client to external devices.

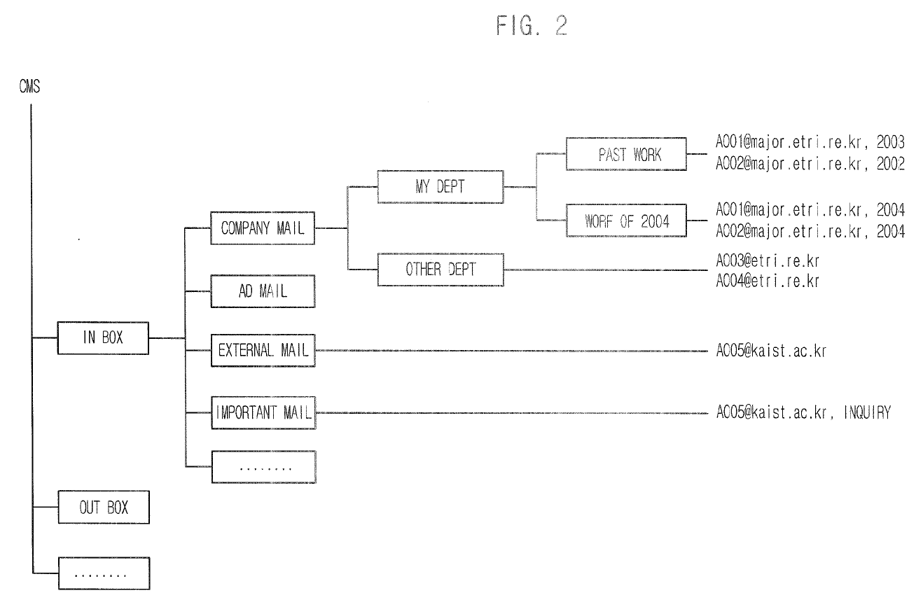

Hereinafter, a method for storing an e-mail according to folders in the client e-mail storing unit 10 will be explained with reference to FIG. 2.

As shown in FIG. 2, in the client e-mail storing unit 10, various folders are created by the client having an e-mail account “CMS” for classifying received e-mails and storing the classified e-mails.

The client e-mail storing unit 10 of the “CMS” client is first divided into an “In Box” folder and an “Out box” folder. The “In Box” folder is further divided to a “company mail” folder, an “ad mail” folder, an “external mail” folder, and an “important mail” folder. The “company mail” folder is also divided according to departments such as a “my department (dept.)” folder and an “other dept” folder. The “my dept” folder is divided to a “past work” folder and a “work of 2004” folder.

Accordingly, the “work of 2004” folder may store e-mails of “A001@major.etri.re.kr, 2003” and “A002@major.etri.re.kr, @2002” as shown in FIG. 2. That is, the e-mails “A001@major.etri.re.kr, 2003” and “A002@major.etri.re.kr, 2002” represent that the e-mails are received e-mails, which are transmitted from a company “etri” and same departments “major”, and they are e-mails received before the year 2004.

Also, e-mails having properties of “A001@major.etri.re.kr, 2004” and “A002@major.etri.re.kr, 2004” are stored in the “work of 2004” folder. That is, the properties of e-mails stored in the “work of 2004” folder represent that they are e-mails from the company “etri”, and the same department “major” and received in 2004.

Also, e-mails “A003@etri.re.kr” and “A004@etri.re.kr” are stored in the “other department” folder. The e-mails “A003@etri.re.kr” and “A004@etri.re.kr” represent that those e-mails are received e-mail, and they are transmitted from another department of the company “etri.”

Furthermore, an e-mail of “A005@kaist.ac.kr” may be stored in the “external mail” folder. The email “A005@kaist.ac.kr” represents that the e-mail is a received e-mail and transmitted from “kaist.”

Moreover, an e-mail “A005@kaist.ac.kr, inquiry” may be stored in the “important mail” folder. The email “A005@kaist.ac.kr, inquiry” represents that the e-mail is a received e-mail and an important (inquiry) e-mail and it is transmitted from “kaist.”

By classifying e-mails according to the folders as mentioned above and marking an e-mail of the folder is received, the client can effectively manage the received e-mails and easily recognize that the e-mail of the folder is received.

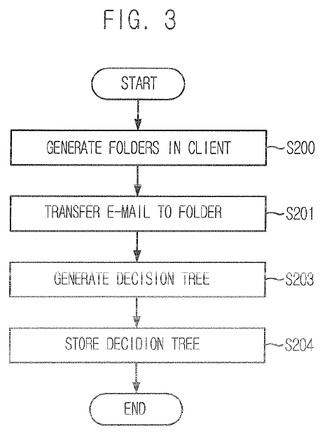

FIG. 3 is a flowchart describing a method for generating a decision tree in accordance with a preferred embodiment of the present invention.

Referring to FIG. 3, folders are created by a client in a client e-mail storing unit 10 at step S200.

E-mails are transferred to the folders at step S201.

A decision tree is generated based on the folders and e-mails stored in corresponding folders at step S203.

The generated decision tree is transferred to the controlling unit 12 at step S204.

Through the process, the preparation of the e-mail classification based on the decision tree is completed.

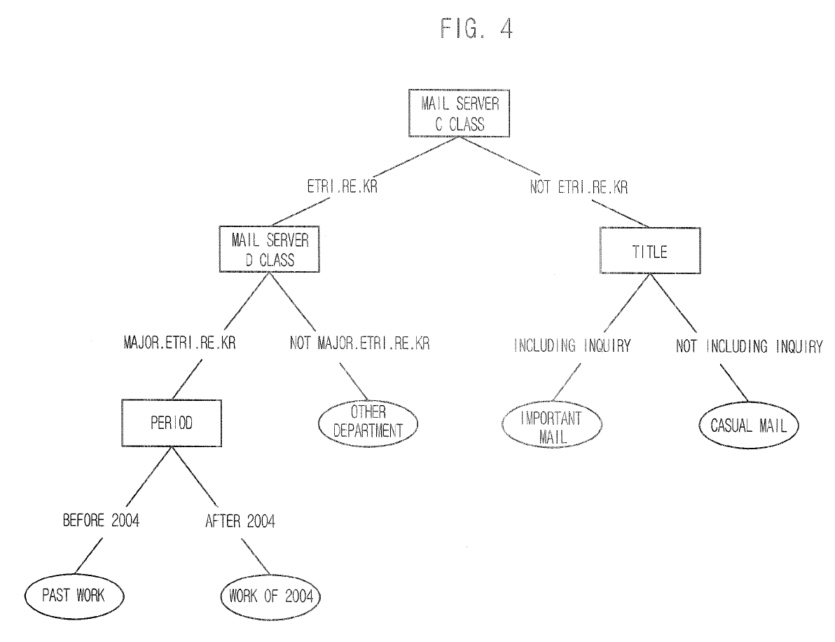

FIG. 4 shows a decision tree in accordance with a preferred embodiment of the present invention.

As shown in FIG. 4, the decision tree has a classification pattern classifying the e-mail to a “mail server D class” and a “title” based on whether it is a mail of a company, e.g., etri.re.kr, beginning from a “mail server C class.” The “mail server D class” is further divided into “period” and “other department” based on whether the department, for example, major.etri.re.kr.

The “period” also has another classifying pattern classifying the email into “past work” and “work of 2004” according to the year of e-mail reception.

The “title” also has another classifying pattern classifying the email to “important mails” and “casual mails” according to significance, e.g., inquiry.

The preferred embodiment of the present invention is explained based on the decision tree having a depth of three steps. However, the depth may be deeper and the depth is not limit the scope of the present invention.

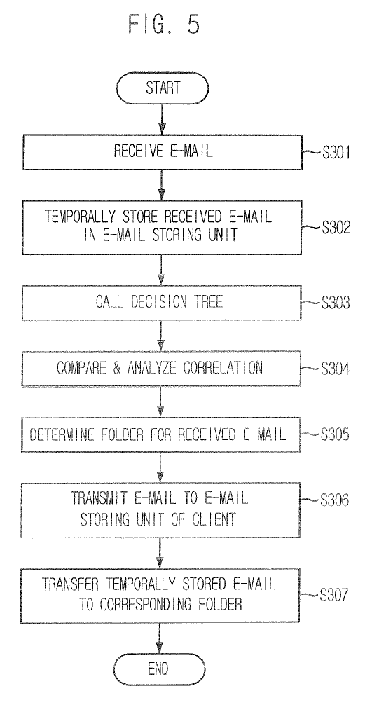

FIG. 5 is a flowchart describing a method for classifying e-mails based on a decision tree in accordance with a preferred embodiment of the present invention.

First, the decision tree is generated through the process shown in FIG. 3.

The e-mails received from the outside are temporally stored in the e-mail storing unit 16 at steps S310 and S302.

Correlation between the received e-mail and the folders is analyzed by calling the decision tree at steps S303 and S304. That is, the received e-mail and the decision tree are compared.

Subsequently, one of folders is determined as a folder for storing the received e-mail and transferred to the client e-mail storing unit 10 to store the e-mail in the folder at steps S305 and S306. Herein, the folder storing the e-mail is a folder turned out to have the highest correlation in the comparison.

At step S307, the temporally stored e-mail is deleted out of the e-mail storing unit 16.

While the present invention has been described with respect to certain preferred embodiments, it will be apparent to those skilled in the art that various changes and modifications may be made without departing from the spirit and scope of the invention as defined in the following claims.

What is claimed is:

1. An apparatus for classifying e-mails by using a decision tree, comprising:
a client e-mail storing means for storing e-mails according to each folder;
a decision tree generating means for generating a decision tree based on information about e-mails stored according to folders in the client e-mail storing means;
a received e-mail processing means for receiving e-mails;
an e-mail storing means for storing the e-mails received in the receiving e-mail processing means;
an e-mail classifying means for classifying the e-mails stored in the e-mail storing means based on the decision tree;
an e-mail transmitting means for transmitting the e-mail classified in the e-mail classifying means to the client e-mail storing unit; and
a controlling means for controlling the above means to generate the decision tree based on information of the e-mails stored according to each folder in the client e-mail storing unit and to classify the e-mail transmitted from outside based on the decision tree.

2. The apparatus as recited in claim 1, wherein the information about e-mails includes an e-mail address, a date of e-mail reception, a class number of a e-mail server and an e-mail title.

3. A method for classifying e-mails based on a decision tree, the method comprising the steps of:
a) generating a decision tree based on information about folders created by a client and e-mails stored in the folders;
b) temporally storing e-mails transmitted from outside in an e-mail storing means;
c) comparing correlation between the folders and the stored e-mail based on the decision tree;
d) determining a folder having highest correlation with the stored e-mail based on the comparison; and
e) storing the e-mail in the above determined folder.

4. The method as recited in claim 3, wherein the information of the e-mails includes an e-mail address, a date of reception, a class number of an e-mail server, and an e-mail title.
